(19) United States
(12) Patent Application Publication
(10) Pub. No.: US 2013/0179208 A1
(43) Pub. Date: Jul. 11, 2013

(54) WORKFLOW TASKS

(71) Applicants: Samuel CHUNG, Seoul (KR); Chetan DANDEKAR, (US); Pauline CHAO, (US); Duhoi HEO, Seoul (KR); Hana LEE, Seoul (KR); Cosmin BARSAN, (US)

(72) Inventors: Samuel CHUNG, Seoul (KR); Chetan DANDEKAR, (US); Pauline CHAO, (US); Duhoi HEO, Seoul (KR); Hana LEE, Seoul (KR); Cosmin BARSAN, (US)

(73) Assignee: Microsoft Corporation, Redmond, WA (US)

(21) Appl. No.: 13/348,475

(22) Filed: Jan. 11, 2012

(51) Int. Cl. G06Q 10/06

(52) U.S. Cl. 705/7.15

(57) ABSTRACT

A system for providing workflow task customization comprises a workflow design tool communicating with a shared application platform. The workflow design tool is configured to receive a task customization selection, receive an initial task property selection, and upon receiving the initial task property selection, display a task customization user interface within the workflow design tool, the task customization user interface configured to receive one or more task property selections and receive a selection of a workflow item association from one or more workflow items stored by the shared application platform. The workflow design tool is further configured to generate a task including the one or more task property selections and associate the selected workflow item to the task.

### BACKGROUND

Workflows are computer-implemented representations of real world processes. Workflows assist users with collaboration on documents and management of project tasks by implementing specific business processes on documents and items. Among other things, workflows also assist organizations with adherence to consistent business processes, and improve organizational efficiency and productivity by managing the tasks and steps involved in specific business processes.

### SUMMARY

A workflow system and method that provides workflow task customization is provided. Workflow tasks may be customized and assigned to one or more workflow users, and one or more approval points may be provided to receive task feedback and update a workflow or workflow item.

Embodiments include a system for providing workflow task customization. The system may include a workflow design tool communicating with a shared application platform, the workflow design tool configured to receive a task customization selection; receive an initial task property selection; and, upon receiving the initial task property selection, display a task customization user interface within the workflow design tool. In embodiments, the task customization user interface is configured to receive one or more task property selections and receive a selection of a workflow item association from the one or more workflow items of the stored workflow. The workflow design tool is further configured to generate a task including the one or more task property selections and associate the workflow item selection to the task.

In other embodiments, a method for providing workflow task customization is disclosed. The method includes receiving a task customization selection within a user interface of a workflow design tool, the task customization selection having an association to a workflow item stored in a shared application platform; and receiving an initial task property selection. Upon receiving the initial task property selection, the method includes displaying a task customization user interface within the workflow design tool and receiving one or more task property selections via the task customization user interface. The method further includes receiving a participant selection of one of: a user group and a plurality of non-grouped users; and receiving a task completion criteria selection.

A computer-readable medium including executable instructions that, when executed by a processor, provide workflow task customization is also disclosed. The instructions include receiving a task customization selection within a user interface of a workflow design tool, the task customization selection having an association to a workflow item stored in a shared application platform; receiving an initial task property selection; and, upon receiving the initial task property selection, displaying a task customization user interface within the workflow design tool. The method further comprises receiving one or more task property selections via the task customization user interface, further including receiving a participant selection of a user group or a plurality of non-grouped users; receiving a selection of a workflow item association from the one or more workflow items of the stored workflow; receiving a task completion criteria selection; receiving a content type selection; and displaying a menu of corresponding outcomes based on the received task content type selection. Further, the method includes generating a task including the one or more task property selections and associating the workflow item selection to the task.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

Referring now to the drawings in which like reference numbers represent corresponding parts throughout:

FIG. 1 shows certain systems and system components for creating workflow tasks;

FIGS. 2A and 2B are a flowcharts of a method for providing workflow task customization according to embodiments;

FIG. 3 illustrates a workflow customization user interface for initiating task creation according to embodiments;

FIG. 4 illustrates a workflow canvas for customizing workflows according to embodiments;

FIGS. 5a and 5b illustrate examples of a task customization user interface according to embodiments;

FIG. 6 illustrates a task participant selection user interface according to embodiments;

FIG. 7 illustrates a string builder and lookup interface according to embodiments;

FIG. 8 illustrates an example of a visualization of a workflow task within a workflow task customization user interface including one or more tasks according to one embodiment according to embodiments; and

FIG. 9 is a simplified block diagram of a computing system with which embodiments of the present invention may be practiced.

### DETAILED DESCRIPTION

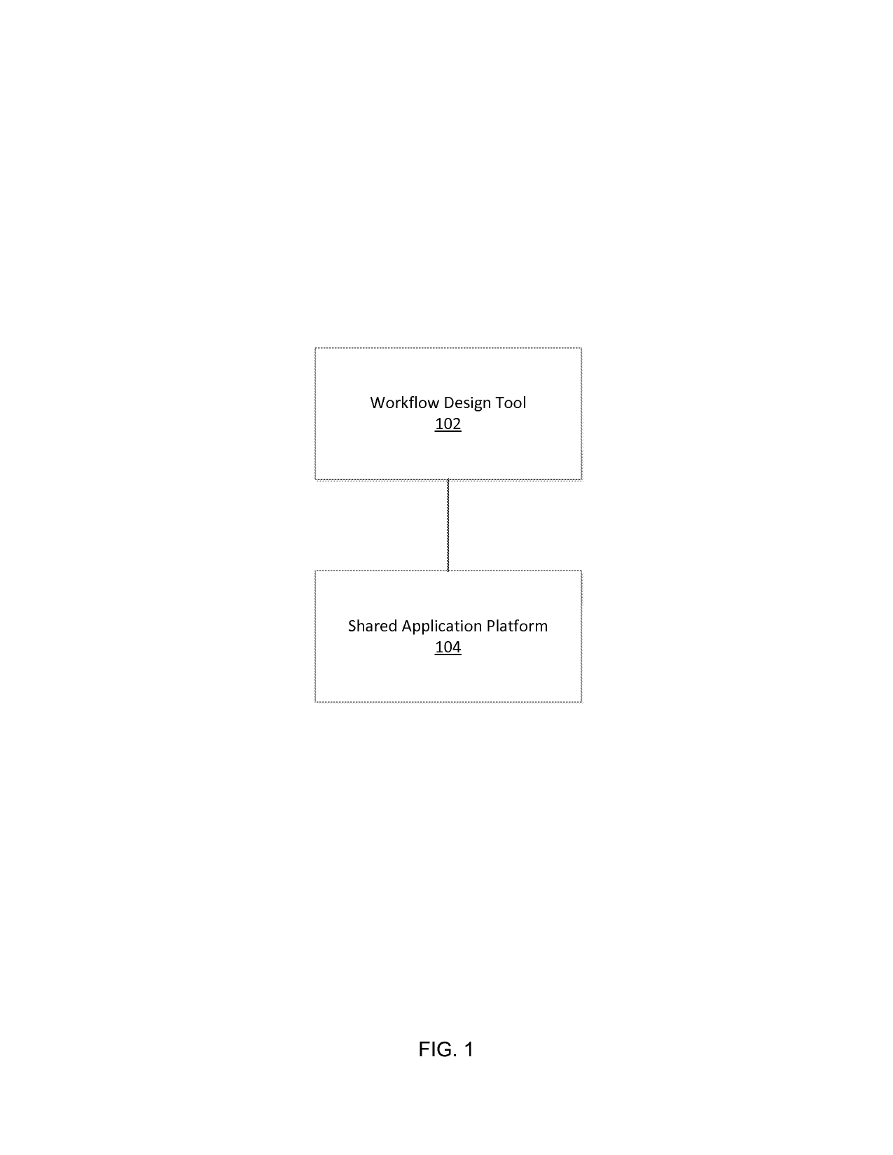

Embodiments of the present invention provide workflow task creation and customization. FIG. 1 illustrates the high level architecture of a system 100 for providing workflows according to embodiments. System 100 may include a workflow design tool 102 communicating with a shared application platform 104. Workflow design tool 102 may be, for example, a version of Microsoft® SharePoint® Designer. Shared application platform 104 may be, for example, Microsoft® SharePoint® or a Microsoft® SharePoint® server. Workflow design tool 102 may be configured to customize one or more workflow tasks for a workflow item stored on the shared application platform 104.

Workflow items may be objects to which a workflow may be associated. Workflow items may include documents, spreadsheets, presentations, etc., upon which a workflow or a workflow task may run after associating the workflow or workflow task to the workflow item. A workflow task may, itself, be a workflow item stored in a workflow task list on, for example, shared application platform 104. In some instances, a workflow task is associated to another workflow item stored on the shared application platform (e.g., an expense report approval task may be associated to the corresponding expense report). Also, a workflow task may include additional properties that other workflow items may lack (e.g., due dates, reminder options, etc.), including properties that may be updated based on changes made to the associated workflow item. To this end, workflow design tool 102 may be configured to customize a workflow task having one or more customizable task properties. Workflow design tool 102 may simplify task customization by allowing a user to select and/or modify one or more task properties in a user-friendly interface without requiring extensive programming knowledge. Workflow design tool 102 may also be configured to format a task according to the selections and assign a task to one or more designated users. Workflow design tool 102 may also be configured to dynamically update one or more task properties based on external modifications to a workflow or workflow item. For instance, a workflow may include an expense report that requires approval by one or more users. A workflow task designer may create and customize an approval task that may be assigned to the one or more users for approval of the expense report. If a user is added to or removed from a list of users needing to approve the expense report, workflow design tool 102 may update the list without having to reconfigure the task or manually update the list of users.

Workflow design tool 102 may be a declarative workflow design application that enables a user to design a workflow using text-based or natural-language sentences that express business process tasks performed by actions. To this end, the workflow design tool 102 may be capable of displaying visible user-interface elements using a declarative markup language, such as Extensible Application Markup Language (XAML). The Extensible Application Markup Language is a declarative Extensible Markup Language (XML)—based language. A declarative markup language, such as XAML, enables a workflow where separate parties can work on the user interface and the logic of an application. Workflow design tool 102 may alternatively be a visual workflow design application. For instance, a visual workflow design application such as Microsoft Visio® may be utilized to create workflows tasks for a workflows by creating visual groupings of workflow tasks and visual connections between the workflow tasks. In embodiments, the workflow design tool 102 may include both visual design and declarative design capabilities.

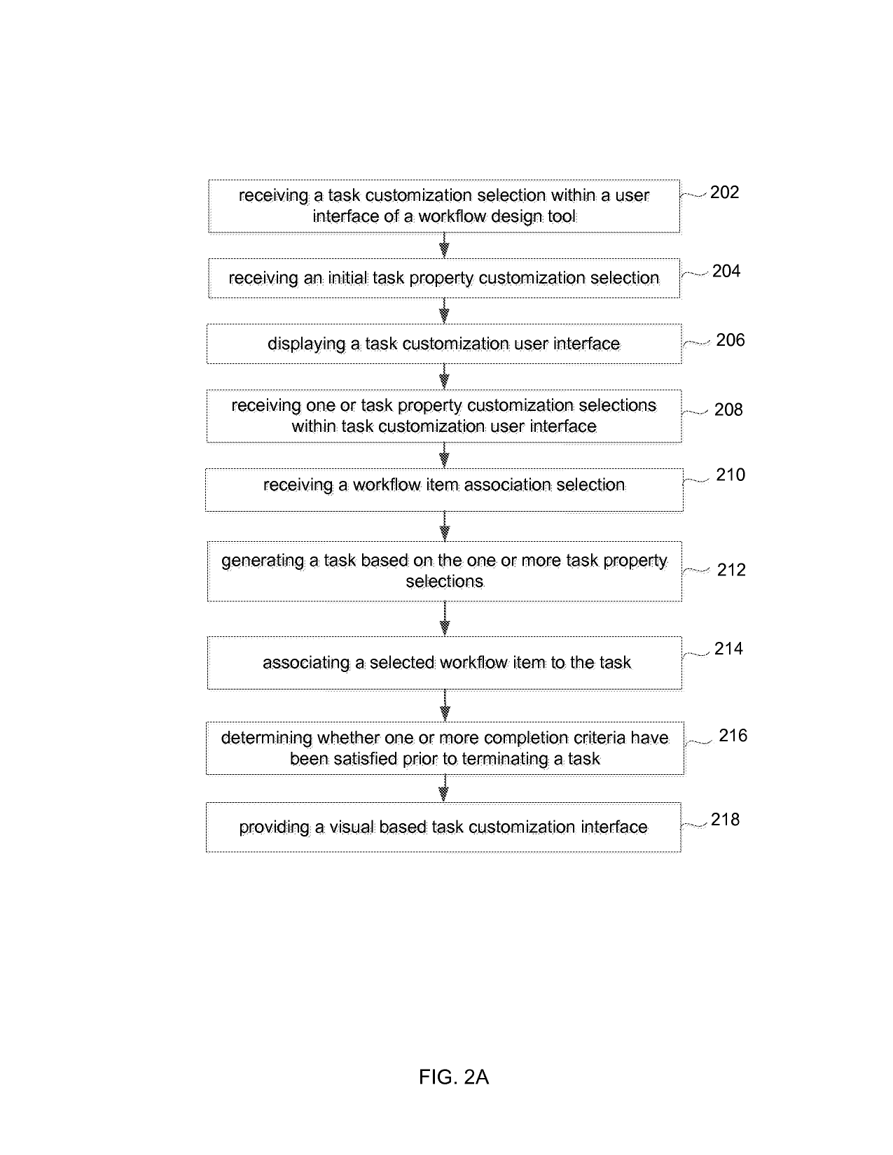

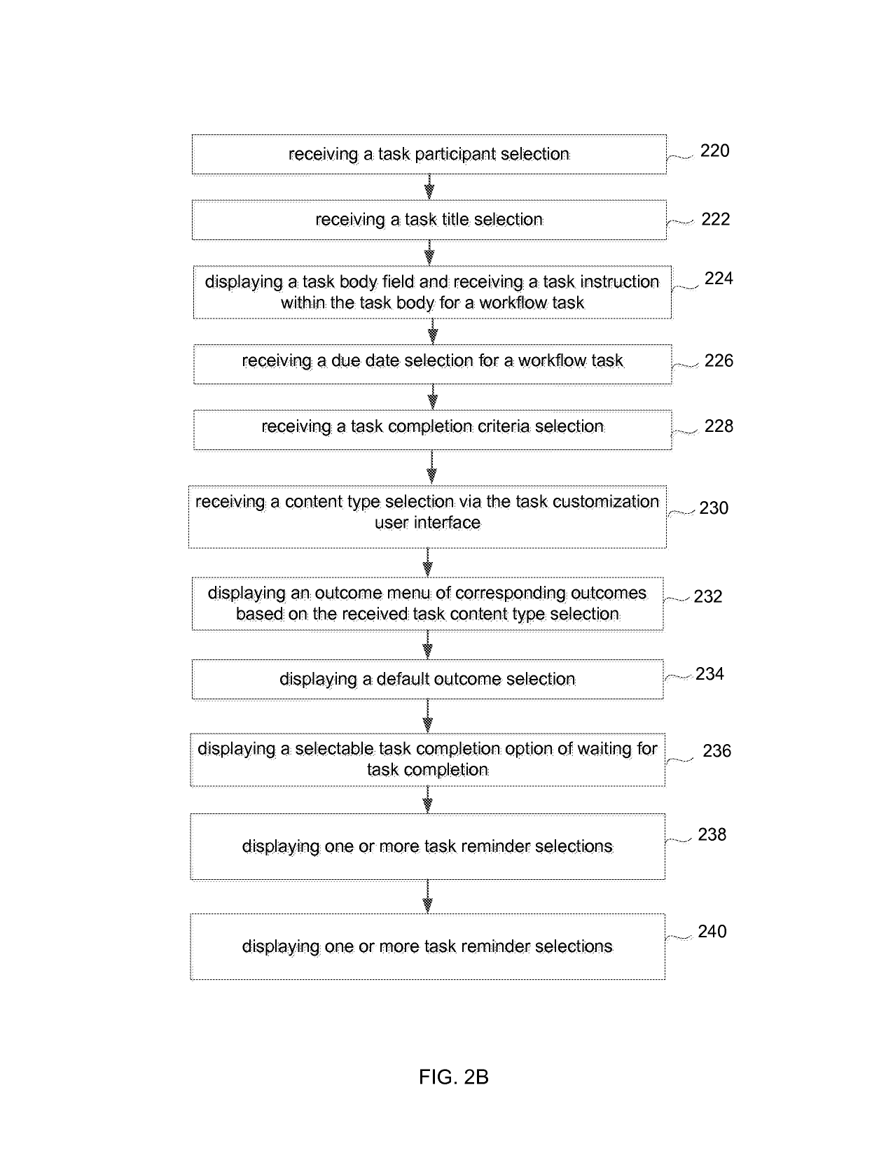

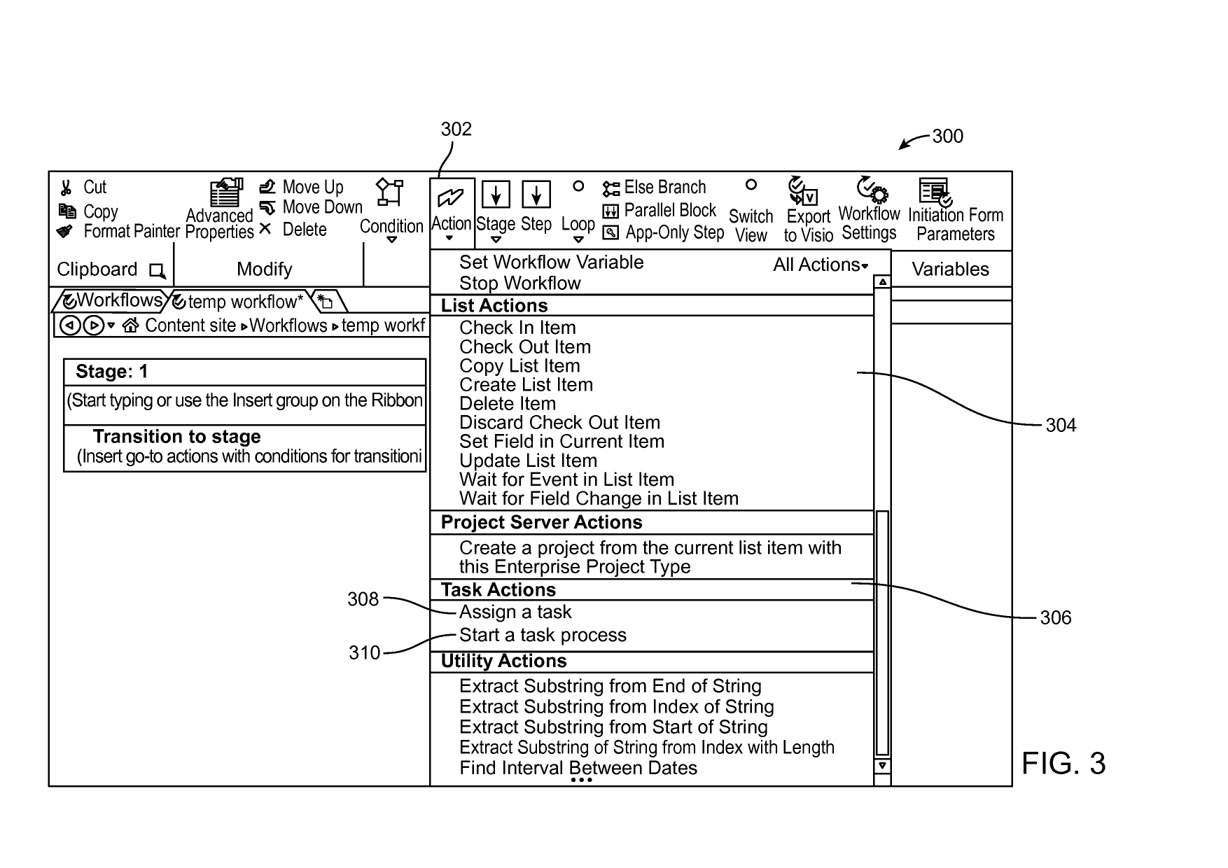

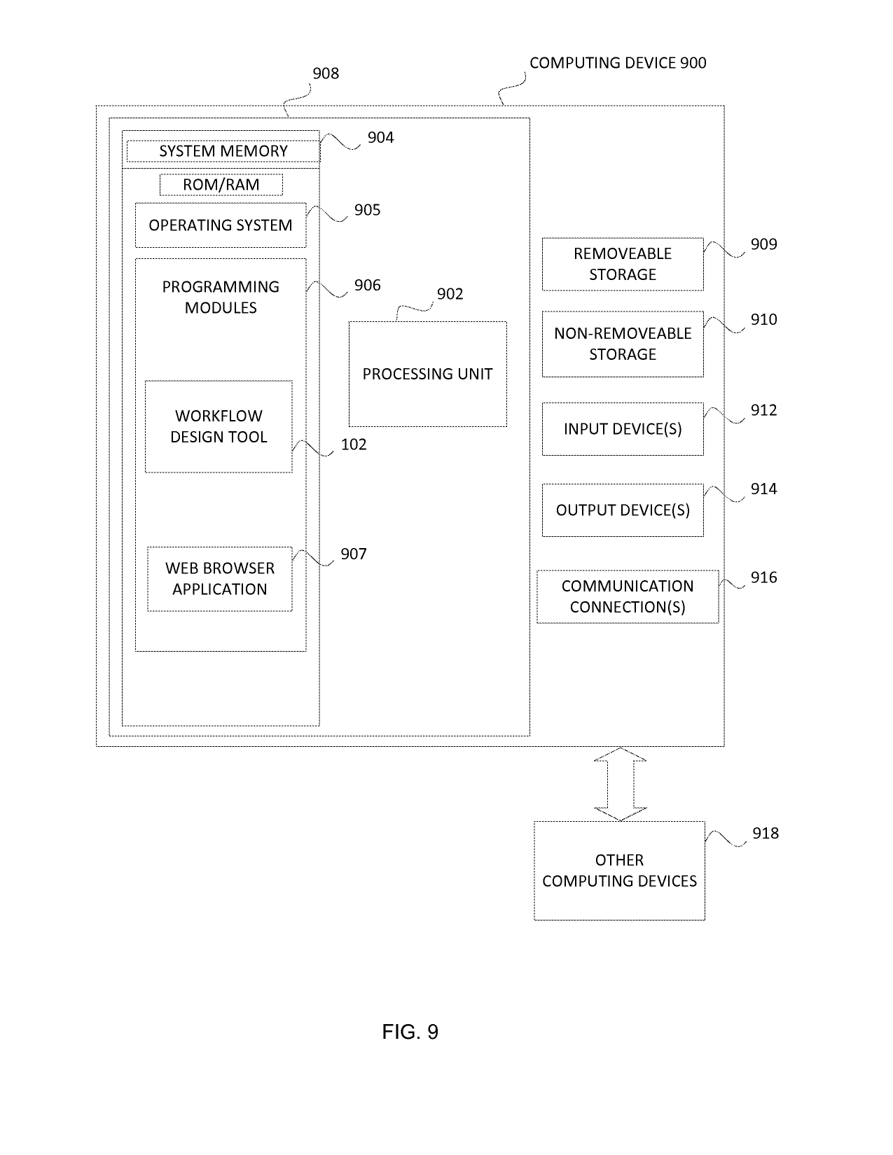

FIGS. 2A and 2B are flowcharts of a method 200 for providing workflow task customization according to an embodiment. The order of operations of FIGS. 2A-2B should not be considered limiting. It is contemplated that method 200 may be performed in any order suitable for task customization according to embodiments of the disclosure. Method 200 is described for illustration purposes only with respect to the user interfaces depicted in FIGS. 3-8 and the systems described with respect to FIGS. 1 and 9; however, it should be apparent that method 200 may be employed with other systems and interfaces. Referring to FIG. 2A, a method 200 for providing workflow task customization is illustrated. Method 200 may include receiving 202 a task customization selection within a user interface of a workflow design tool, such as workflow design tool 102. For example, to generate a customized workflow task, workflow design tool 102 may be configured to receive a task customization selection. FIG. 3 illustrates one embodiment of a workflow customization user interface 300 for receiving a task action selection from a user, thereby initiating the task customization process according to embodiments of the disclosure. As shown in FIG. 3, workflow customization user interface 300 may include a selectable Action tab 302. Workflow design tool 102 may receive an Action tab 302 selection through workflow customization user interface 300. Action tab 302 selection may result in the display of drop-down menu 304, or any alternate means (e.g., a pop-out dialog box) for providing a user selectable tasks list, for example, Task Actions list 306. Task Actions list 306 may display one or more task actions including, for example, “Assign a task” 308 and “Start a task process” 310.

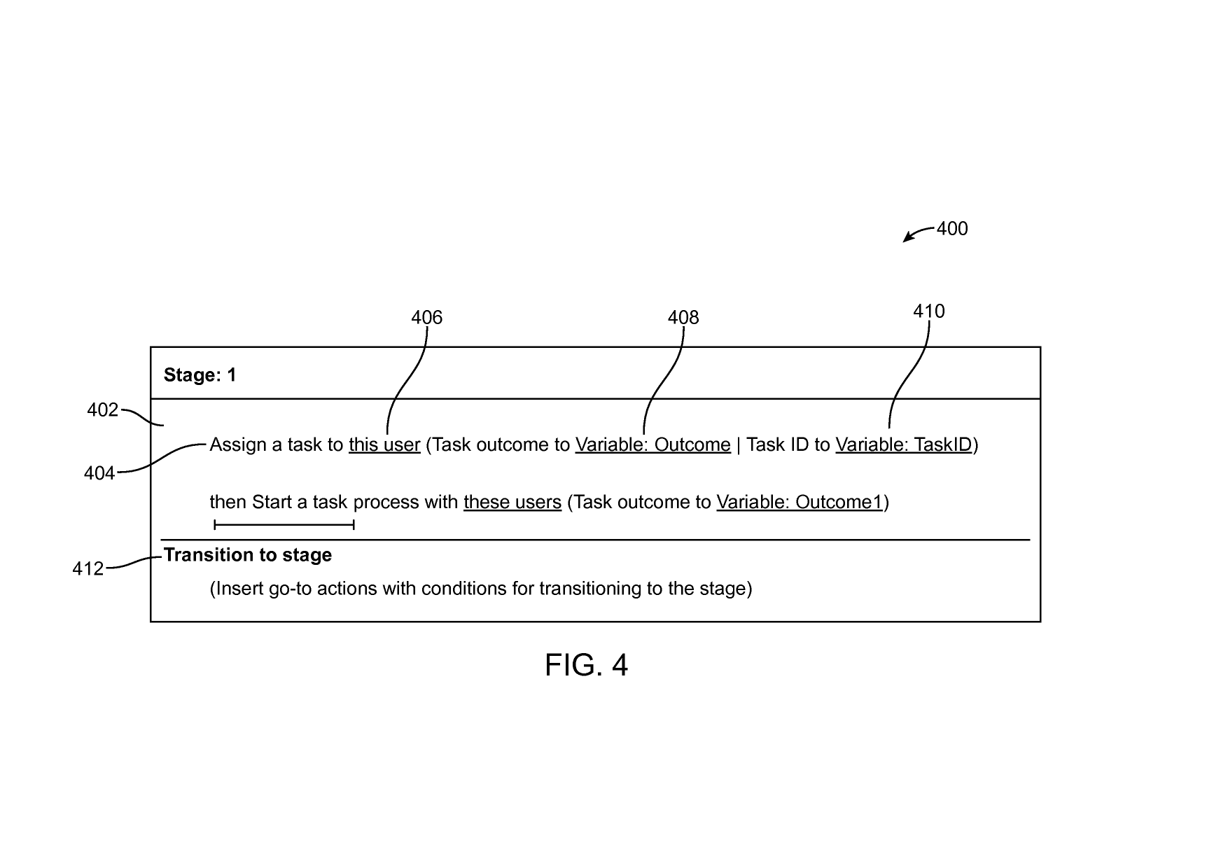

A selection of a task action may be received (e.g. from a user) from drop-down menu 304 of Action tab 302 to begin the task customization process. FIG. 4 illustrates a workflow customization canvas 400 of general workflow customization user interface 300 that may be utilized for editing one or more workflow task action sentences using a text-based workflow editor. In one embodiment, selecting a task action 308, 310 from the Action tab 302 of workflow customization user interface 300 may activate a workflow customization canvas 400. In embodiments, when activated, the workflow customization canvas 400 may be displayed in a separate window, as a popup within the same window, or as part of workflow customization user interface 300, or otherwise. In one embodiment, upon selection of a task action such as “Assign a task” 308 or “Start a task process” 310 actions of FIG. 3, a task action sentence 404 may be inserted into a workflow action customization section 402 of workflow customization canvas 400. Alternative design interfaces that provide a new task creation starting point may be utilized. For instance, tasks may be customized with a design interface that uses visual based workflow logic.

In embodiments, selection of “Assign a task” 308 from task action list 306 may provide an indication that a single user or user group may be desired for an assigned task. As a result, a simplified task action sentence may be displayed. A “Start a task process” 310 selection may indicate that multiple grouped or non-grouped users may be desired for an assigned task. In this configuration, a displayed task action sentence may include more customization options than are displayed in the simplified task action sentence. In other embodiments, similar action sentences are displayed upon selecting either “Assign a task” 308 or “Start a task process” 310, with one or more task customization options made unavailable (e.g., locked or greyed out) to a user customizing a simplified task (e.g., a task requiring a response from one user or one user in a user group).

As shown in FIG. 4, task action sentence 404 may include, for example: Assign a task to this user (Task outcome to Variable: Outcome|Task ID to Variable: Task ID) then Start a task process with these users (Task outcome to Variable: Outcome1). The above task action sentence 404 is discussed by way of example only. It is contemplated that any other appropriate task action may be selected as desired by a workflow user and any task action sentence may appear as a result of a task action selection.

Task action sentence 404 may include one or more selectable task properties 406, 408, and 410. The one or more selectable task properties 406, 408, and 410 may include, for example, one or more user segments and/or one or more variables that may be selected for use in the workflow task. As shown in FIG. 4, workflow customization canvas 400 may display one or more customizable task properties 406, 408, and 410 (e.g., the “this user” 404, “Variable: Outcome” 408, and “Variable: Task ID” 410) properties of the action sentence 404. Task properties 406, 408, and 410 may be selectable to customize task action properties.

Workflow customization canvas 400 may also provide stage transition customization. In embodiments, a stage transition customization section 412 may be displayed and present a user with one or more customizable stage transition options. Stage transitions may be insertable action sentences including one or more go-to commands for transitioning to another workflow stage, for instance, after task completion, if desired.

Upon receiving a task customization selection 202, method 200 may include receiving 204 an initiate task property customization selection. For instance, workflow design tool 102 may receive a task action selection of one or more of selectable task properties 406, 408, and 410 and utilize the task action selection to initiate the task property customization. In some embodiments, workflow design tool 102 may be configured to display a task customization user interface upon receiving a selection of a task action from user interface 300. Upon receiving 204 an initiate task property customization selection, method 200 may include displaying 206 a task customization user interface. For instance, as shown in FIG. 4, workflow design tool 102 may receive an initiate task customization selection (e.g., “this user” 406) selection within workflow customization canvas 400. In other embodiments, a task customization user interface may display directly after selection of a task action, such as “Assign a task” 308 or “Start a task process” 310 actions of FIG. 3.

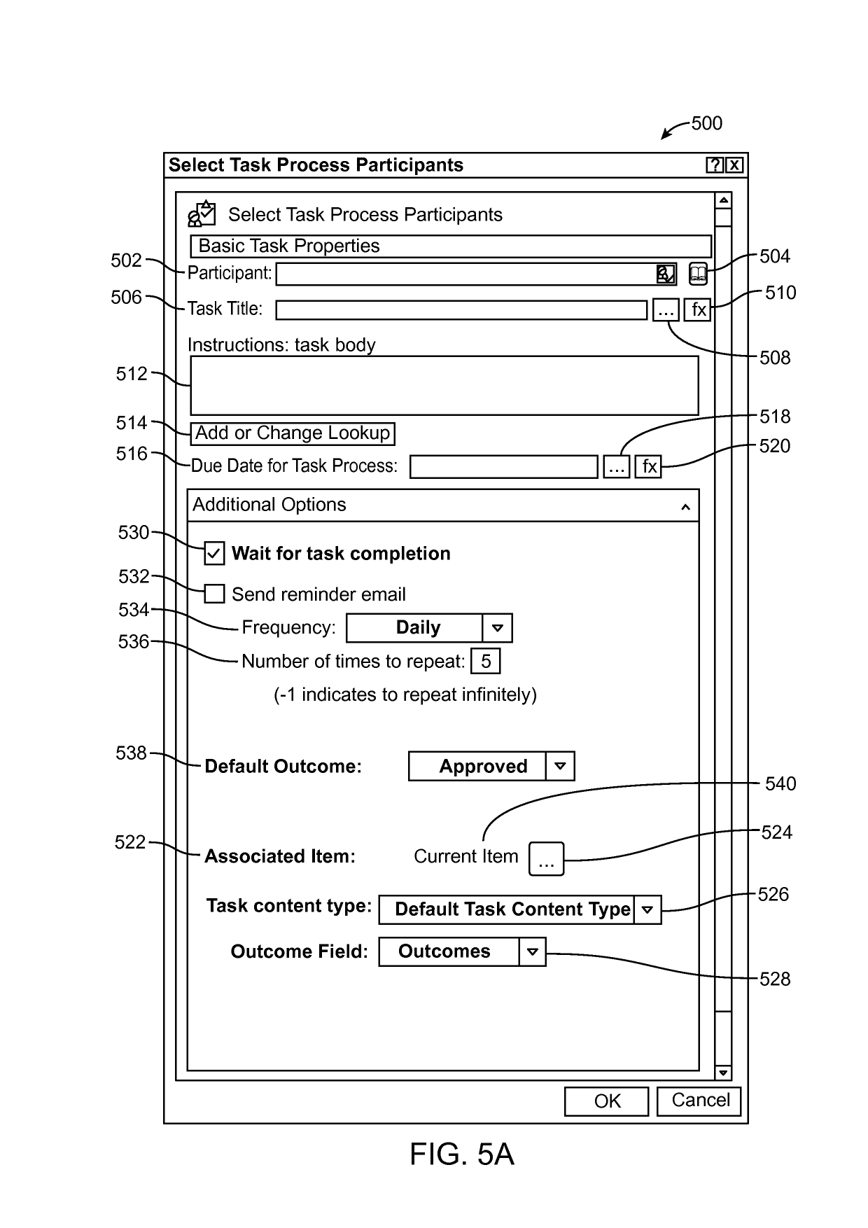

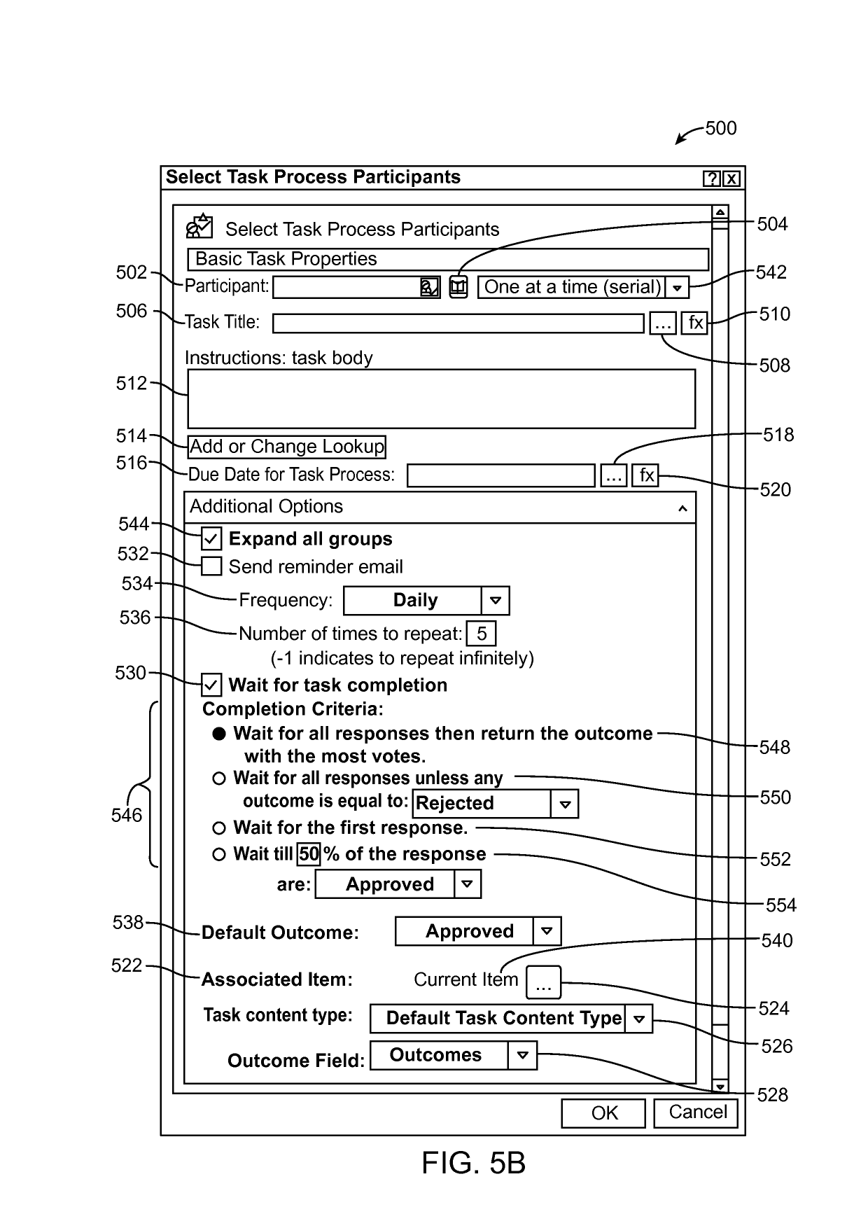

Method 200 may include receiving 208 one or task property customization selections within task customization user interface 500. FIGS. 5A and 5B illustrate an example task customization user interface 500 that may be displayed. Task customization user interface 500 may be a dialog box or other such interface for customizing task properties configured to display one or more customizable task properties. FIG. 5A illustrates a simplified user interface for customizing one or more task properties. A simplified user interface may be suitable for a task customization process requiring a response from a single user. For instance, in embodiments where a single user or a single user group selection is received, a generated task may be sent to the user or user group. A task may be complete upon receipt of a response from the single user or from one user of the user group. FIG. 5B illustrates a task customization user interface configured to receive task customization selections for a single task that may be sent to multiple users and require individual responses, discussed further below. In some embodiments, a similar user interface is displayed, with one or more task customization properties made unavailable (e.g., locked or greyed out) to a user customizing a simplified task (e.g., a task requiring a response from one user or one user in a user group).

Task customization user interface 500 is configured to receive task property customization selections and utilize the task property customization selections to configure the task according to the selections. For instance, a user may select one or more task properties such as a task participant, a task title, and/or a task due date, and may also enter task instructions or notes into a task body. Workflow design tool 102 may then assign the customized task to one or more users (e.g., task assignees or participants).

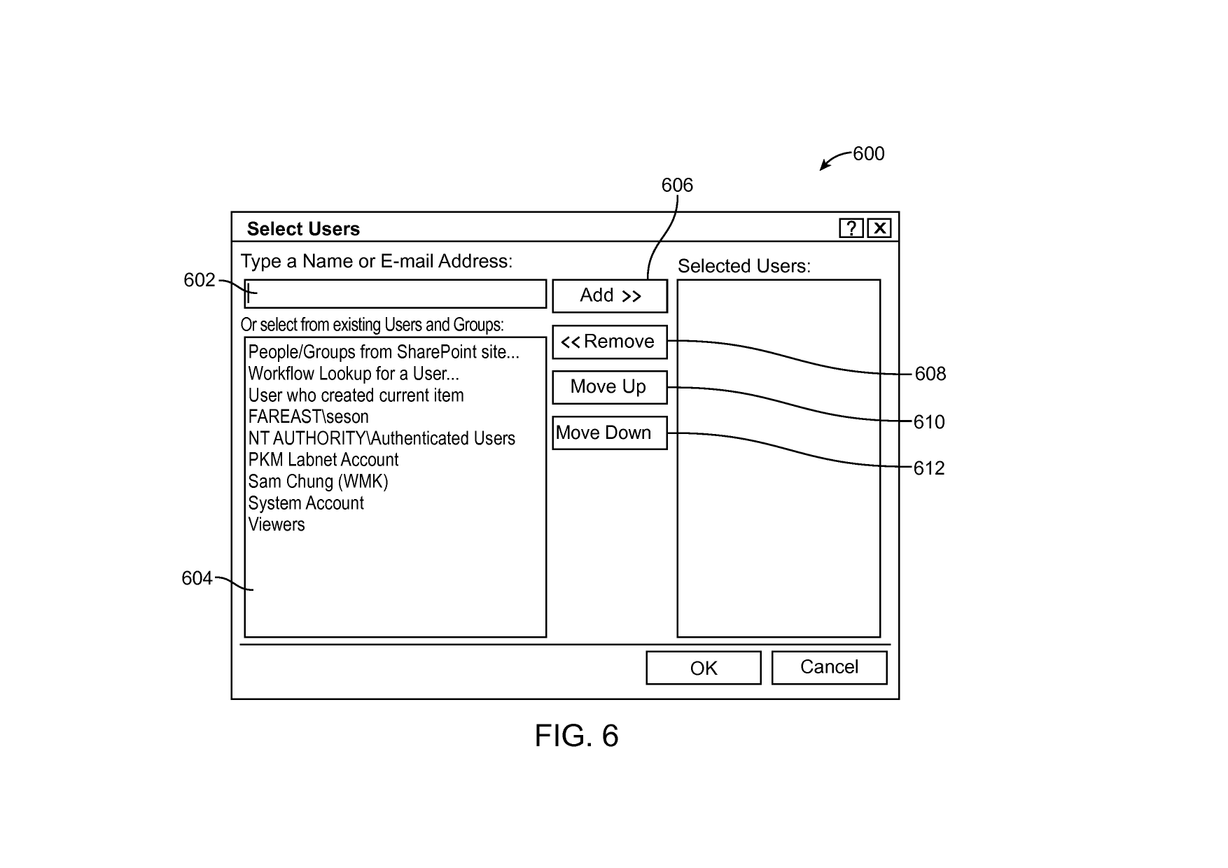

FIG. 2B is a flowchart illustrating one or more task customization property selections. As illustrated in FIG. 2B, receiving 208 one or more task property selections 220-240. In one embodiment method 200 may include receiving 220 a task participant selection within the task customization user interface 500. In some embodiments, task customization user interface 500 may receive a task participant selection of a user, a user group (e.g., an externally defined list of users such as a department or other external list or grouping of users stored, for example, on shared application platform 104), or a plurality of non-grouped users. Task customization user interface 500 may display a participant name field 502 for entering a participant name. One or more task participant selections may then be received by workflow design tool 102. A task participant name may be manually entered into participant name field 502. Alternatively, a task participant may be selected from a task participant selection interface. FIG. 6 illustrates a task participant selection interface 600 that may display upon selection of participant field populator icon 504. Task participant selection interface 600 may allow a user to select a participant user or user group from one or more stored groups. Task participant selection interface 600 may include a name field 602 for entering user name or e-mail address. Task participant selection interface 600 may also display a list 604 of selectable users and/or groups. Task participant selection interface 600 may include one or more icons 606, 608, 610, 612 for selected users and/or user groups to be modified (e.g., added, removed, and/or moved up or down) in a participant list. Upon receipt of a user selection, workflow design tool 102 may then look up the selected user or user group in the shared application platform 104 and assign the task to selected user, each user in the selected user group, or each selected non-grouped user.

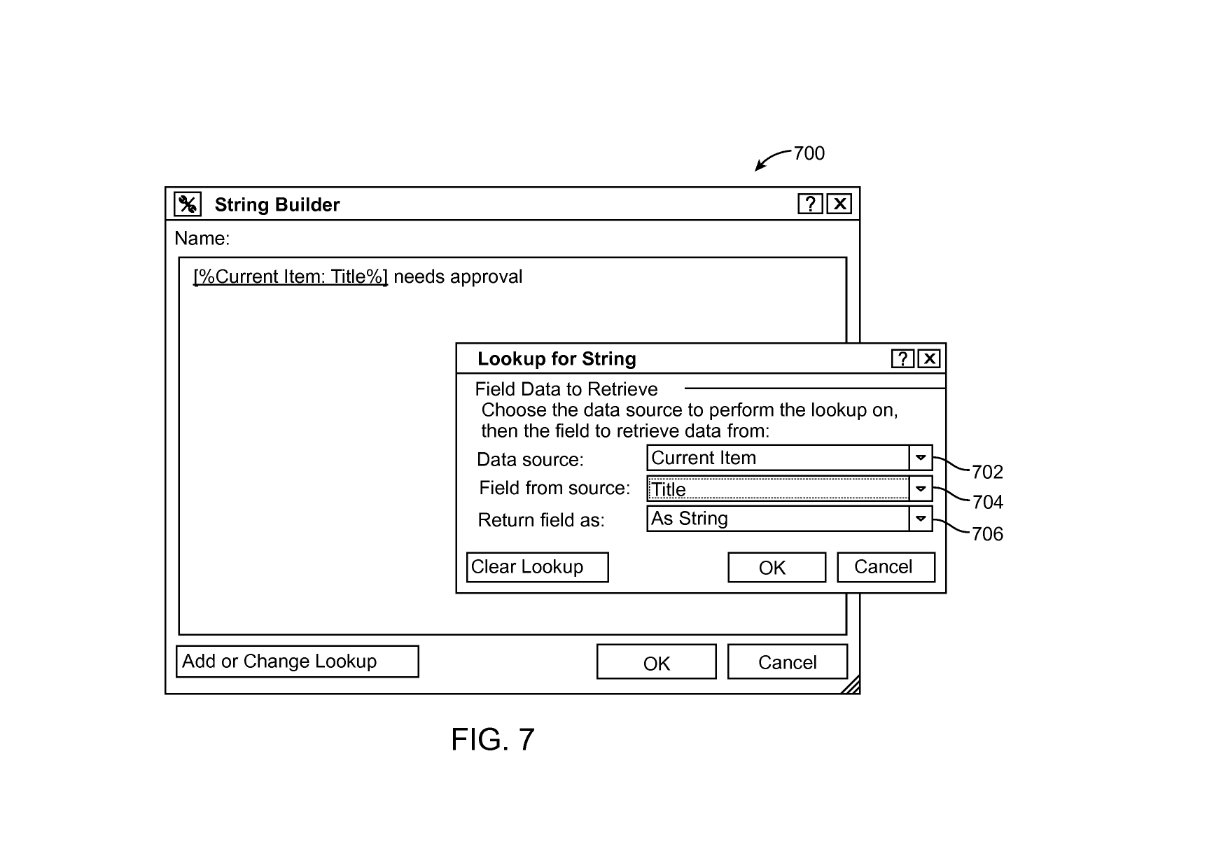

To further customize the task, method 200 may include receiving 222 a task title selection. For instance, task customization user interface 500 may display title field 506 for entering a task title. A task title name may be entered into title field 506 by a user. A string builder icon 508 may also be displayed and selected for task title processing. FIG. 7 illustrates a string builder interface 700 and a lookup interface providing additional task title processing options. A task title may be dynamically updated via string builder interface 700. String builder icon 508 may be provided to execute string builder interface 700 capable of receiving input instructions for dynamically updating a task title if, for example, an associated aspect of a workflow item (e.g., item name) is modified in another application (e.g., in shared application platform 104, or in another interface of workflow design tool 102). FIG. 7 also illustrates lookup dialog that may execute upon selection of function icon 510 (e.g., “Lookup for String” dialog overlaid on string builder interface 700 of FIG. 7). A user may select the function icon 510 in the task customization user interface 500 and a lookup (e.g., a pop-out dialog box) may be displayed with item values retrieved from the shared application platform 104. “Lookup for String” dialog may be utilized, for instance, to select one or more items on which the workflow task will run and associate the selected item to the task title. For instance, a data source prompt 702 may be displayed within the lookup dialog to guide a user to select a data source (e.g., a category of available items, such as “Current Item” as shown in FIG. 7). A user may then be guided to select a field name 704 (e.g., a “Title” field as shown in FIG. 10). “Lookup for String” dialog may receive a selection for a format 706 in which one or more discovered items corresponding with the selected field name may be returned (e.g., the “As String” as shown in FIG. 7). Once the selections are received, the workflow design tool 102 may store the selected data source, field name, and item data. The task title item association may then be stored and passed to workflow task upon execution of the workflow task. Alternatively, a task title may be selected from a task title selection interface (not shown).

Method 200 may also include displaying 224 a task body field and receiving a task instruction within the task body for a workflow task. For instance, task customization user interface 500 may display a task body field 512 for entering task instructions or notes. Task instructions or notes may be entered within task body field 512 by a user. Task instructions or notes may also be associated to a workflow item via a lookup that dynamically updates instructions or notes to correspond with, for instance, an associated workflow item modification. For example, Add or Change Lookup icon 514, or, in some instances, “Open editor for body” (not shown), may be selected to execute a string builder to create a dynamic task body entry that may update if a workflow item is modified by, for example, a user in another application (e.g., in shared application platform 104, or in another interface of workflow design tool 102). A user may select the Add or Change Lookup icon 514 in the task customization user interface 500, and a string builder interface may display, such as shown in FIG. 7. String builder interface may display a selectable option for selecting and displaying a lookup dialog (such as “Lookup for String” dialog of FIG. 7). As described above, lookup dialog may also display selectable item values retrieved from the shared application platform 104. The item associations created within the task body field may then be stored and passed to workflow task upon execution of the workflow.

Method 200 may include receiving 226 a due date selection for a workflow task. For instance, task customization user interface 500 may display a due date field 516 for entering a due date. One or more due date selections may be received by workflow design tool 102. For instance, a due date may be entered into due date field 516 through user interface 500. A due date field populator 518 may also be displayed to allow a user to select a due date rather than type in a due date value. Due date may also be configured via a due date lookup (similar to lookup interface 700) that dynamically updates a due date to correspond with, for instance, an associated workflow item due date. For example, function icon 520 may be selected and may execute a lookup dialog (e.g., “Lookup for String” dialog of FIG. 7) for creating a dynamic due date that may update if, for instance, a workflow item due date is modified in another application (e.g., in shared application platform 104, or in another interface of workflow design tool 102). A user may select function icon 520 in the task customization user interface 500 and a lookup dialog may display with due date values retrieved from the shared application platform 104. The due date value may then be stored and passed to workflow task upon execution of the workflow task.

Additional task property selections may be displayed in task customization user interface 500. Additional task property selections may enable a user to customize task features such as task reminders, completion criteria, content type, item association, etc. FIG. 5B illustrates a task customization user interface configured to receive task customization selections for a single task that may be sent to multiple users and require individual responses. To this end, method 200 may include receiving 228 a task completion criteria selection that is different depending on whether one or more participants are selected for the task. As discussed above, task customization user interface 500 may receive 210 a task participant selection of multiple grouped or non-grouped users. In some embodiments, a generated task may be sent to each user in the user group or to each of the plurality of non-grouped users, and may require a response from at least two users in the user group or the plurality of non-grouped users. In this manner, workflow design tool 102 may assign the same task to multiple task participants and then wait for a response from one or more of the participants prior to terminating the task. A received response may provide an indication that one or more of the assigned tasks is complete (e.g., that one or more assigned participants have completed the task). Thus, although multiple participants may be assigned the task, the completion of the overall task process may require only a subset of tasks to be complete. For instance, task customization user interface 500 may display one or more task completion criteria 546. The task completion criteria selection may include waiting for a response from each of the plurality of users or each user in the user group and returning a most selected response 548. For instance, an expense report approval task may be sent to three or more managers, and the expense report approval task may be terminated only upon receiving a response from each manager, with the outcome decided by approval or rejection of the expense report by a majority of the managers. The task completion criteria selection may alternatively include waiting for a response from each of the plurality of users and returning a most selected response unless at least one response is a designated default task termination response 550. For instance, an expense report approval task may be sent to three or more managers, and the expense report approval task may be terminated by approval of the expense report by a majority of the managers, or by rejection of the expense report by one of the managers. The task completion criteria selection may include waiting for a first response from one of the plurality of users or a user in the user group and returning the first response 552. For instance, an expense report approval task may be sent to two or more managers, and the expense report approval task may be terminated upon receipt of a first response (e.g., approved) from any of the managers. The task completion criteria selection may include waiting to receive a designated portion of responses from the plurality of users or the users in the user group including at least one response option and returning a response corresponding to the at least one response option 554. For instance, an expense report approval task may be sent to three or more managers, and the expense report approval task may be terminated by approval (or disapproval) of the expense report by a majority of the managers. “Approved” or “Rejected” completion criteria are selectable from drop-down menus of response option 550 and/or 554 to increase completion criteria flexibility. Completion criteria may be defined in the positive or negative, or in response to other task customization selections (e.g., t-shirt size, ratings scale, etc.). Any other task completion criteria may be displayed for selection by a user, and the examples described above are in no way limiting.

Method 200 may further include a receiving 238 a request to dynamically update a user group. For instance, the task customization user interface 500 may be configured to receive a request to dynamically update a user group (e.g., receiving a selection of “expand all groups” box 544 of FIG. 5B). At run-time, workflow design tool 102 may dynamically update the selected user group. Updating the user group may be based on, for instance, changes to an associated externally defined user group (e.g., if a user is added to or deleted from the externally defined user group). If a modification is made to the externally defined user group (such as a group that is managed by shared application platform 104), the participants in the task participant selection may then be updated and the updated task participant selection may be passed to the workflow task upon execution of the workflow. The selected user group may be updated prior to each instantiation of the workflow or even after the workflow has been instantiated. This may be advantageous in instances where a set of task participants may not be known or finalized at workflow design-time. Also, task participants may be added or removed after a long-running workflow has been instantiated.

Method 200 may also include receiving 210 an associated workflow item selection. The customized task may be associated to a workflow item. Task customization interface 500 may include an item indicator (e.g., “Associated Item” indicator 522 of FIGS. 5A and 5B) for displaying an item selection. In some instances, the associated workflow item may be a pre-selected default item (e.g., “Current Item” 540 as shown in FIGS. 5A and 5B). “Current Item” 540 may display if, for instance, a task is being customized for a list workflow (e.g., a workflow that runs against a shared application platform 104 list), then the associated item may be a pre-determined item on which the list workflow will run. In a list workflow, workflows are generally run on items that have been created (or, in some instances, modified). In this configuration, the item on which the workflow may run may be “Current Item” 540. Specifically, “Current Item” 540 may reference the shared application platform 104 list item to which the workflow is associated, and the task action may be associated to the workflow item (e.g., a workflow definition of the workflow running on the item). A workflow definition may be, for example, an XML file including workflow information required to instantiate and run the workflow. Workflow information may include, for instance, the name, GUID, and description of the workflow, the uniform resource locators (URLs) of any custom forms used in the workflow, any custom workflow metadata, etc.

If a task is customized for a site workflow (e.g., a workflow that can run against an entire site) the associated item may be customizable to provide a user an opportunity to select an item to which the task may be associated. The associated item may be available via a lookup by selecting string builder icon 524. A string builder interface, similar to string builder interface 700 of FIG. 7, may display and may be utilized to look up any stored workflow items and select a workflow item to which a workflow task may be associated as described above. Selected workflow item may be associated to customized workflow task at run-time.

Method 200 may include displaying 230 a task content type selection and receiving a content type selection via the task customization user interface. The task customization user interface 500 is configured to receive a task content type selection. Workflow design tool 102 may display, for instance, content type menu 526. Content type menu 526 may include a default content type. For instance, a default content type may be to approve or reject an associated item (e.g., an expense report). A custom content type may also be provided. For instance, a task may be created for one or more users to select a t-shirt size. A custom content type (e.g., “size”) may be created within the workflow design tool 102 prior to task customization and may be available for selection upon display of the task customization interface 500. For instance, workflow design tool 102 may scan a list of available content types stored on the shared application platform 104 and display any available content types within task customization user interface 500. If a custom content type is selected, one or more other task property selections may be modified. For example, the Approved/Rejected dropdown menus of task completion criteria 550 and 554 may display other options based on a selected custom content type.

Method 200 may also include displaying 232 an outcome menu of corresponding outcomes based on the received task content type selection. Task customization user interface 500 may display a task outcome menu 528 displaying one or more selectable task outcomes (e.g., selectable by an assigned user in response to receiving the task). Selectable task outcomes may update based on the selected task content type. For instance, the task customization user interface 500 may display a menu of corresponding outcomes based on the received task content type selection. Default outcomes (e.g., approve/reject) and/or custom outcomes (e.g., small, medium, and large) may be displayed in the outcome menu 538.

Method 200 may include displaying 234 a default outcome selection. The task customization user interface 500 is further configured to display a default outcome menu 538 including one or more default outcomes (e.g., “approved” or “rejected”) and receive a default task outcome selection. Default outcome menu 538 may be updated based on content type selection.

Method 200 may also include displaying 236 a selectable task completion option of waiting for task completion. A selectable “wait for task completion” box 530 may be displayed within task customization user interface 500. In some instances, task customization user interface 500 may receive a selection of waiting for task completion (e.g., selection of “Wait for task completion” box 530). In a “wait for task completion” configuration, a task may need to be completed prior to transitioning to one or more additional workflow steps (e.g., activities, actions, stages etc.). To this end, workflow design tool 102 may be configured to pause the workflow until the task is complete. In other instances, such as for passive tasks or tasks that do not affect the current or subsequent workflow step (e.g., “read the attached e-mail”), a user may de-select “Wait for task completion” box 530, allowing a the workflow step including the task to execute and transition to a subsequent workflow step without waiting for task completion.

Method 200 may include displaying 240 one or more task reminder selections. Task customization user interface 500 may display one or more task reminder selections. A user may customize one or more reminder options. For instance, one or more selectable reminder options may include “send reminder e-mail” 532, further including customizable duration selections of frequency 534 and number of times to repeat 536. In one embodiment, if frequency 534 and number of times to repeat 536 have been customized (e.g., daily), workflow design tool 102 may be configured to generate a reminder activity that can “sleep” until a reminder is to be sent again, and may repeat the sleep cycle after sending a reminder until a number of times to repeat 536 has been exhausted.

Method 200 may include generating 212 a task based on the one or more task property selections. Workflow design tool 102 may be capable of generating a workflow task based on the selected task properties. Method 200 may also include associating 214 a selected workflow item to the task. For instance, workflow design tool 102 may associate the selected workflow item (e.g., the item selected via the “Associated Item” user interface element 522) to the customized task. Upon execution of the workflow on the selected item, the task action may be executed and one or more tasks may be created.

Method 200 may include generating 234 a task alert message and delivering (e.g., via e-mail) a generated task alert message to the one or more users at run-time according to the task reminder selections. Workflow design tool 102 may verify if a selected reminder option has been set and deliver the generated task alert message to at least one user (e.g., the single selected user, each of the users in the selected user group or each of the plurality of selected non-grouped users). One or more follow-up messages (e.g., additional reminder, past due) may also be generated and sent to a user. In embodiments, workflow design tool 102 may determine if a task has expired (e.g., a task due date has passed) and deliver a task expiration message to at least one user. Method 200 may include determining 216 whether one or more completion criteria have been satisfied prior to terminating a task. Workflow design tool 102 is configured to receive responses from users and terminate a task based on the selected task completion criteria. A task may only be complete upon receiving a designated type of response based on one or more customized completion criteria.

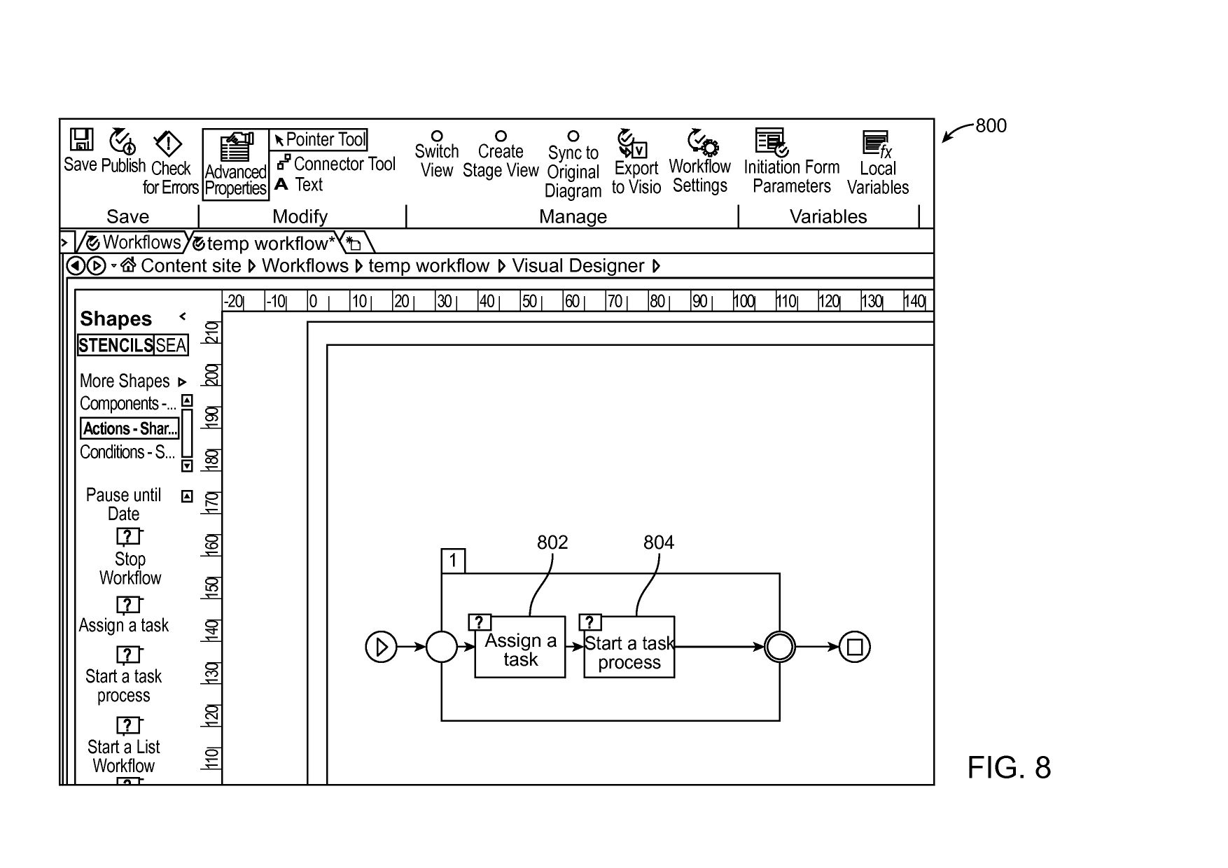

Method 200 may also include providing 218 a visual based task customization interface. FIG. 8 illustrates an example of a visual user interface 800 for customizing one or more task properties. Visual user interface 800 may be provided within workflow design tool 102, or may be included in a standalone application operably connected to the workflow design tool 102 and/or the shared application platform 104. A task action shape (e.g., “Assign a task” 802 shape or “Start a task process” 804 shape of FIG. 8) may be dragged and dropped onto a visual workflow design canvas. “Assign a task” shape 802 or “Start a task process” shape 804 may be selected by a user and task properties may be displayed for modification, using either a visual based workflow tool or a text-based workflow tool. For instance, upon selecting the “Assign a task” 802 shape or the “Start a task process” 804 shape, user interface 500 may display. A user may then review a task, or configure a task according to desired task properties as described above.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 9 and its associated description provide a discussion of a variety of operating environments in which embodiments may be practiced. However, the devices and systems illustrated and discussed with respect to FIG. 9 are for purposes of example and illustration and are not limiting of a vast number of computing device configurations that may be utilized for practicing embodiments, described herein.

FIG. 9 is a block diagram illustrating example physical components of a computing device 900 with which embodiments may be practiced. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905, one or more programming modules 906, and may include the workflow design tool 102 for providing workflow task customization. Operating system 905, for example, may be suitable for controlling the operation of computing device 900. Furthermore, embodiments may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910.

As stated above, a number of program modules and data files may be stored in system memory 904, including operating system 905. While executing on processing unit 902, programming modules 906, such as the workflow design tool 102, may perform processes including, for example, one or more of the processes described above with reference to FIGS. 1-8. The aforementioned processes are an example, and processing unit 902 may perform other processes. Other programming modules that may be used in accordance with embodiments may include electronic mail and contacts applications, word processing applications, spreadsheet applications, database applications, slide presentation applications, drawing or computer-aided application programs, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip containing electronic elements or microprocessors. For example, embodiments may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the workflow design tool 102 may be operated via application-specific logic integrated with other components of the computing device/system 900 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, may be implemented as a computer process (method), a computing system, or as an article of manufacture, such as a computer program product or computer-readable storage medium. The computer program product may be a computer-readable storage medium readable by a computer system and encoding a computer program of instructions for executing a computer process.

The term computer-readable storage medium as used herein may include computer storage media. Computer storage media may include volatile and nonvolatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) such as a display, speakers, a printer, etc. may also be included. The aforementioned devices are examples and others may be used.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments herein may be used in connection with mobile computing devices alone or in combination with any number of computer systems, such as in desktop environments, laptop or notebook computer systems, multiprocessor systems, micro-processor based or programmable consumer electronics, network PCs, mini computers, main frame computers and the like. Embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments.

Embodiments, for example, are described above with reference to block diagrams and/or operational illustrations of methods, systems, and computer program products according to embodiments. The functions/acts noted in the blocks may occur out of the order as shown in any flowchart or described herein with reference to FIGS. 1-8. For example, two processes shown or described in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable storage media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

It will be apparent to those skilled in the art that various modifications or variations may be made to embodiments without departing from the scope or spirit. Other embodiments are apparent to those skilled in the art from consideration of the specification and practice of the embodiments disclosed herein.

What is claimed:

1. A system for providing workflow task customization comprising:
a workflow design tool coupled to the shared application platform, the workflow design tool configured to:
receive a task customization selection;
display a task customization user interface within the workflow design tool, the task customization user interface configured to:
receive one or more task property selections; and
receive a selection of a workflow item association from one or more workflow items stored by the shared application platform;
wherein the workflow design tool is further configured to generate a task including the one or more task property selections and associate the selected workflow item to the task.

2. The system of claim 1, wherein the one or more task customization selections include at least one of:
a participant selection;
a task title selection; and
a due date selection.

3. The system of claim 2, wherein the task customization selection is the participant selection and comprises a selected user group.

4. The system of claim 3, wherein the task customization user interface is configured to receive a request to dynamically update the selected user group and the workflow design tool is configured to dynamically update the selected user group based on changes to an associated externally defined user group.

5. The system of claim 1, wherein the selected workflow item is a default workflow item and the task customization user interface is configured to display a default workflow item name upon receiving a task customization selection.

6. The system of claim 1, wherein the selected workflow item is selectable from a list of available workflow items.

7. The system of claim 1, wherein the workflow design tool is configured to electronically deliver a generated task message alert to at least one user.

8. The system of claim 1, wherein the task customization user interface is further configured to receive a default task outcome selection.

9. The system of claim 1, wherein the task customization user interface is configured to receive a task content type selection.

10. The system of claim 9, wherein the task customization user interface displays a menu of corresponding outcomes based on the received task content type selection.

11. A method for providing workflow task customization comprising:
receiving a task customization selection within a user interface of a workflow design tool, the task customization selection having an association to a workflow item stored in a shared application platform;
displaying a task customization user interface within the workflow design tool; and
receiving one or more task property selections via the task customization user interface further including:
receiving a participant selection of one of: a user group and a plurality of non-grouped users; and
receiving a task completion criteria selection.

12. The method of claim 11, wherein the task completion criteria selection includes:
waiting for a response from each of the users in the participant selection and returning a most selected response.

13. The method of claim 11, wherein the task completion criteria selection includes:
waiting for a first response from one of the users in the participant selection and returning the first response.

14. The method of claim 11, wherein the task completion criteria selection includes:
waiting for a response from each of the users in the participant selection and returning a most selected response unless at least one response is a designated default task termination response.

15. The method of claim 11, wherein the task completion criteria selection includes:
waiting to receive a designated portion of responses from the users in the participant selection including at least one response option and returning a response corresponding to the at least one response option.

16. The method of claim 11, further including dynamically updating the user group based on changes to an associated externally defined user group.

17. The method of claim 11, further including:
receiving a content type selection via the task customization user interface; and
displaying a menu of corresponding outcomes based on the received task content type selection.

18. The method of claim 11, further including:
generating a task based on the one or more task property selections; and
associating a selected workflow item of the stored workflow to the task.

19. The method of claim 18, further including electronically delivering a generated task alert message to at least one user.

20. A computer-readable medium comprising executable instructions that, when executed by a processor, provide workflow task customization, the instructions comprising:
receiving a task customization selection within a user interface of a workflow design tool, the task customization selection having an association to a workflow item stored in a shared application platform;
displaying a task customization user interface within the workflow design tool;
receiving one or more task property selections via the task customization user interface further including:
receiving a participant selection of a user group or a plurality of non-grouped users;
receiving a selection of a workflow item association from the one or more workflow items of the stored workflow;
receiving a task completion criteria selection;
receiving a content type selection; and
displaying a menu of corresponding outcomes based on the received task content type selection; and
generating a task including the one or more task property selections and associating the workflow item selection to the task.
